(19) United States
(12) Patent Application Publication
(10) Pub. No.: US 2013/0095882 A1
(43) Pub. Date: Apr. 18, 2013

(54) WIRELESS TERMINAL DEVICE AND WIRELESS COMMUNICATION METHOD

(71) Applicant: FUJITSU MOBILE COMMUNICATIONS LIMITED, Kawasaki-shi (JP)

(72) Inventor: Naritoshi SAITO, Hino (JP)

(73) Assignee: FUJITSU MOBILE COMMUNICATIONS LIMITED, Kawasaki-shi (JP)

(21) Appl. No.: 13/645,301

(22) Filed: Oct. 4, 2012

(30) Foreign Application Priority Data
Oct. 14, 2011 (JP) 2011-227327

(51) Int. Cl. H04W 88/06

(52) U.S. Cl. 455/552.1

(57) ABSTRACT

A wireless terminal device includes a mode selecting unit that selects a WiMAX only communication mode in which communication is performed by a WiMAX scheme or a WiMAX dual communication mode in which communication is performed using the WiMAX scheme and an EV-DO scheme together, according to an input signal input through an input control unit. The wireless terminal device further includes a threshold value control unit that sets a connection determination threshold value, which is used to determine whether or not to establish a wireless connection by the WiMAX scheme, to a different value according to the wireless communication mode selected by the mode selecting unit.

### CROSS-REFERENCE TO RELATED APPLICATION

This application is based upon and claims the benefit of priority of the prior Japanese Patent Application No. 2011-227327, filed on Oct. 14, 2011, the entire contents of which are incorporated herein by reference.

### FIELD

The embodiment discussed herein is directed to a wireless terminal device and a wireless communication method.

### BACKGROUND

In recent years, various communication schemes such as CDMA (Code Division Multiple Access) 2000, CDMA2000 1x, and CDMA2000 1xEV-DO (Evolution-Data Only) have been proposed as 3G (3rd Generation) mobile communication schemes. CDMA2000 1x is one of technical specifications included in the CDMA2000 standard, and CDMA2000 1xEV-DO is a standard which is improved from CDMA2000 1x and specialized in data communication to increase the communication speed. In the following, “CDMA2000 1x” may be abbreviated to “1x,” and “CDMA2000 1xEV-DO” may be abbreviated to “EV-DO.”

In addition, various data communication schemes such as a fixed wireless communication standard (WiMAX (a registered trademark): Worldwide Interoperability for Microwave Access) and a wireless LAN standard (WiFi (a registered trademark): Wireless Fidelity) have been proposed.

For example, in communication schemes in which a service is provided from relatively long ago such as 1x and EV-DO, since many base stations are installed, a communication area (service area) is very large. However, the WiMAX scheme, the WiFi scheme, and the like are relatively new services and spread centering on highly-populated urban areas, and thus services are provided in a relatively narrow communication area included in a communication area of 1x or EV-DO.

Under such circumstances, in recent wireless terminal devices such as portable telephones, for example, multi-mode wireless terminal devices that support a plurality of communication schemes such as 1x, the EV-DO scheme, and the WiMAX scheme have been provided.

For example, in the multi-mode wireless terminal devices, a communication mode in which packet communication is performed using both the WiMAX scheme and the EV-DO scheme or a communication mode in which packet communication is performed only by the WiMAX scheme can be selected according to a user's operation. In other words, in a WiMAX Dual (WiMAX+EV-DO) communication mode in which both the WiMAX scheme and the EV-DO scheme are used, a wireless terminal device is connected with a WiMAX base station when the wireless terminal device is located in a WiMAX communication coverage. Further, in the WiMAX dual communication mode, when the wireless terminal device moves and is outside the WiMAX coverage, the wireless terminal device is connected to the EV-DO base station and performs packet communication. However, in the WiMAX only communication mode in which packet communication is performed only by the WiMAX scheme, when the wireless terminal device is inside the WiMAX communication coverage, the wireless terminal device is connected with the WiMAX base station, whereas when the wireless terminal device is outside the WiMAX coverage, the wireless terminal device does not perform packet communication.

Patent Literature 1: Japanese National Publication of International Patent Application No. 2011-522467

However, the related art does not give any consideration on suppression of power consumption when the communication mode using a plurality of communication schemes is selected.

In other words, in the related art, even when either of the WiMAX only mode and the WiMAX dual mode is selected, a connection determination threshold value used to determine whether or not wireless communication is to be performed by the WiMAX scheme is used fixedly to a connection determination threshold value of the WiMAX only mode. For example, an RSSI (Received Signal Strength Indicator) or a CINR (Carrier to Interference and Noise Ratio) of a radio signal transmitted from the WiMAX base station is used as the connection determination threshold value of the WiMAX scheme.

For example, when the WiMAX only mode is selected, the connection determination threshold value of the WiMAX scheme is set to be small. For example, an RSSI threshold value is set to −89 dBm, and a CINR threshold value is set to 0 dB. Through this setting, when the wireless terminal device is located near the boundary of the WiMAX communication area, a WiMAX wireless connection can be rapidly established even though the RSSI or the CINR of the WiMAX is low.

On the other hand, even when the WiMAX dual mode is selected, if the same connection determination threshold value as in the WiMAX only mode is used, switching to a WiMAX connection is rapidly performed even in a situation in which the RSSI or the CINR of the WiMAX is low. However, when switching to a WiMAX connection is performed in a state in which the RSSI or the CINR of the WiMAX is low, then the RSSI of the WiMAX becomes weak, or stability of a WiMAX connection becomes worse, switching to an EV-DO connection may be immediately performed. As described above, switching between the WiMAX connection and the EV-DO connection is frequently performed in a state in which a WiMAX wireless connection is unstable. A large amount of electric current flows to the wireless terminal device each time switching is performed, and thus power consumption of the wireless terminal device may be increased.

### SUMMARY

According to an aspect of an embodiment, a wireless terminal device that is able to perform communication by a plurality of communication schemes includes: a processor that selects a first wireless communication mode in which communication is performed by a first wireless scheme or a second wireless communication mode in which communication is performed using a plurality of communication schemes including the first wireless scheme, according to an input signal input through an input interface, and sets a connection determination threshold value, which is used to determine whether or not to establish a wireless connection by the first wireless scheme, to a different value according to the selected wireless communication mode.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating a relation between a 1x/EV-DO communication area and a WiMAX communication area;

FIG. 2 is a diagram illustrating an example of a network architecture of WiMAX/EV-DO;

FIG. 3 is a diagram illustrating a hardware configuration of a wireless terminal device;

FIG. 4 is a diagram illustrating functional blocks of a processor;

FIG. 5 is a diagram illustrating an example of selecting a communication mode on a screen of a wireless terminal device;

FIG. 6 is a diagram illustrating an example of a communication mode selection register;

FIG. 7 is a diagram illustrating an example of RSSI/CINR threshold values in a WiMAX only communication mode and a WiMAX dual communication mode;

FIG. 8 is a diagram illustrating an example of a frame format of a WiMAX physical channel;

FIG. 9 is a diagram illustrating an example of a synchronization and initial ranging process of WiMAX communication; and

FIG. 10 is a flowchart of a process of setting an RSSI threshold value and a CINR threshold value of a wireless terminal device.

### DESCRIPTION OF EMBODIMENTS

Preferred embodiments will be explained with reference to accompanying drawings. A technique of the disclosure is not limited to the following embodiment.

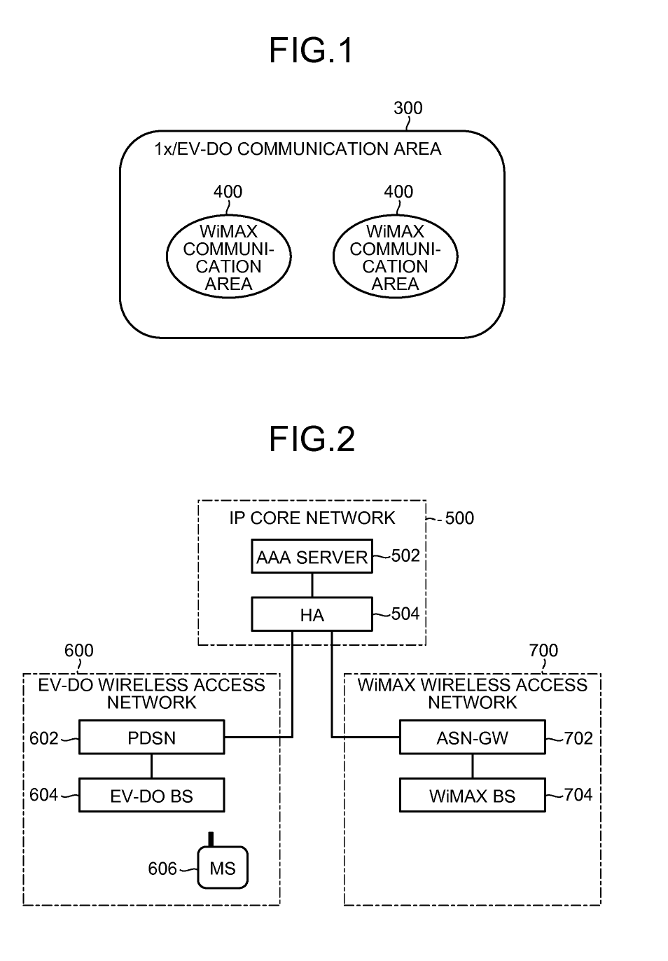

First, a relation between a 1x/EV-DO communication area and a WiMAX communication area will be described. FIG. 1 is a schematic diagram illustrating a relation between a 1x/EV-DO communication area and a WiMAX communication area. Since the 1x/EV-DO communication scheme is a communication scheme in which a service is provided from relatively long ago, many base stations are installed, and a 1x/EV-DO communication area 300 covered by many base stations is large as illustrated in FIG. 1.

On the other hand, the WiMAX scheme is a relatively new service and so spread centering on highly-populated urban areas. For this reason, a WiMAX communication area 400 is narrower than the 1x/EV-DO communication area 300. As illustrated in FIG. 1, a relation between the 1x/EV-DO communication area 300 and the WiMAX communication area 400 is a relation in which the WiMAX communication area 400 is included in the 1x/EV-DO communication area 300.

As described above, a multi-mode wireless terminal device that supports a plurality of communication schemes is provided under a situation in which a service is provided by a plurality of communication schemes such that communication areas overlap. A network architecture by a plurality of communication schemes will be described in connection with an example of a multi-mode of the WiMAX and the EV-DO.

FIG. 2 is a diagram illustrating an example of a network architecture of WiMAX/EV-DO. As illustrated in FIG. 2, in the WiMAX/EV-DO network architecture, since packet communication is performed by IP continuity (IP sharing), an IP core network 500 is shared by an EV-DO wireless access network 600 and a WiMAX wireless access network 700. An IP Continuity technique is described in detail in IEEE Communications Magazine (June 2009) pp 122-pp 131 “WiMAX-EVDO Interworking Using Mobile IP”, written by Peretz Feder, Ramana Isukapalli, and the like.

The EV-DO wireless access network 600 is a network that performs wireless communication a MS (Mobile Station) 606 through the EV-DO scheme of the CDMA2000 and transmits data by a packet switching scheme. Examples of the MS 606 include a portable telephone, a smart phone, and a wireless terminal device having a wireless communication function. The EV-DO wireless access network 600 is connected with the IP core network 500. The EV-DO wireless access network 600 includes a plurality of EV-DO base stations including an EV-DO base station (BS) 604, and PDSN (Packet Data Serving Node) 602. Each EV-DO base station forms a cell, and a set of cells forms the EV-DO wireless access network 600.

The EV-DO base station 604 performs a wireless communication with the MS 606, and performs wire communication with the PDSN 602. The EV-DO base station 604 transfers packet data between the MS 606 and the PDSN 602. The PDSN 602 is a gateway device connected with the IP core network 500.

The WiMAX wireless access network 700 is a network that performs wireless communication with the MS 606 by the WiMAX scheme, and transmits data by a packet switching scheme. The WiMAX wireless access network 700 is connected with the IP core network 500. The WiMAX wireless access network 700 includes a plurality of WiMAX base stations including a WiMAX base station 704, and an ASN (Access Service Network)-GW (GateWay) 702. Each WiMAX base station forms a cell, and a set of cells forms the WiMAX wireless access network 700.

The WiMAX base station 704 is a communication device that performs wireless communication with the MS 606, and performs wire communication with the ASN-GW 702. The WiMAX base station 704 transfers data of a packet form between the MS 606 and the ASN-GW 702. The ASN-GW 702 is a gateway device connected with the IP core network 500, and transfers packet data.

The IP core network 500 is an IP network that controls data communication of the MS 606, and transmits data by the packet switching scheme. The IP core network 500 is connected with the EV-DO wireless access network 600 and the WiMAX wireless access network 700. The IP core network 500 includes an AAA (Authentication, Authorization and Accounting) server 502 and an HA (Home Agent) 504.

The AAA server 502 is a server device that performs authentication of the MS 606 and accounting on a user of the MS 606. The HA 504 is a communication device that registers the MS 606 that uses the EV-DO wireless access network 600 or the WiMAX wireless access network 700, and transfers data of the MS 606 based on registration information. The HA 504 checks which of the EV-DO wireless access network 600 and the WiMAX wireless access network 700 which the MS 606 uses to perform data communication. The HA 504 transfers data addressed to the MS 606 selectively to the EV-DO wireless access network 600 or the WiMAX wireless access network 700.

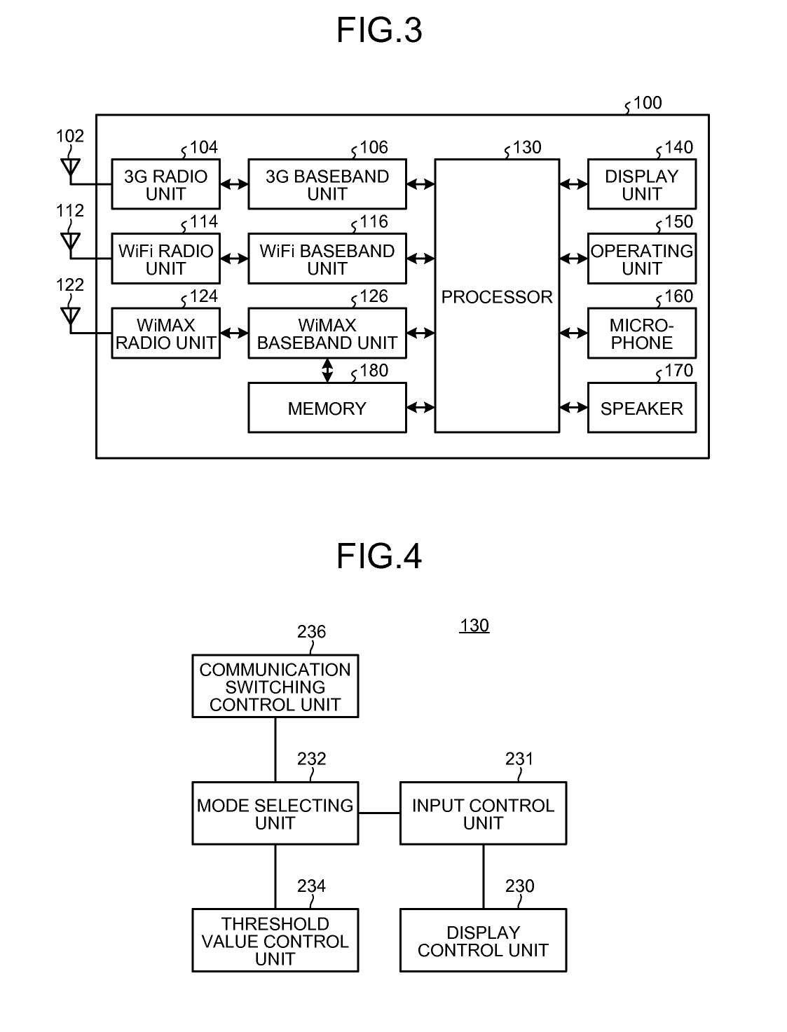

Next, a hardware configuration of a portable telephone will be described. FIG. 3 is a diagram illustrating a hardware configuration of a wireless terminal device. As illustrated in FIG. 3, a wireless terminal device 100 includes a 3G antenna 102, a 3G radio unit 104, a 3G baseband unit 106, a WiFi antenna 112, a WiFi radio unit 114, and a WiFi baseband unit 116. The wireless terminal device 100 further includes a WiMAX antenna 122, a WiMAX radio unit 124, a WiMAX baseband unit 126, a processor 130, a display unit 140, an operating unit 150, a microphone 160, a speaker 170, and a memory 180.

The 3G radio unit 104 receives a radio signal of a variety of data such as a sound or a text that conforms to, for example, the 1x/EV-DO scheme through the 3G antenna 102, performs frequency transform on the radio signal, and outputs a frequency transform result to the 3G baseband unit 106. For example, the 3G radio unit 104 includes a transmitter, a multiplier, an amplifier, an attenuator, an AGC (Automatic Gain Control), and the like, and is implemented by an analog circuit and the like. Further, the 3G radio unit 104 performs frequency transform on a signal output from the 3G baseband unit 106, and transmits the signal which has been subjected to the frequency transform to the outside through the 3G antenna 102.

The 3G baseband unit 106 converts a signal received through the 3G radio unit 104 into a baseband signal, and then converts the converted signal into a digital signal by an A(Analog)/D(Digital) converter. The 3G baseband unit 106 performs various processes such as a demodulation process and an error correction process on the converted digital signal. For example, the 3G baseband unit 106 is implemented by a CPU (Central Processing Unit), a DSP (Digital Signal Processor), or the like.

The WiFi radio unit 114 receives a radio signal of a variety of data such as a sound or a text that conforms to, for example, the WiFi scheme which is a wireless LAN standard through the WiFi antenna 112, performs frequency transform on the radio signal, and outputs a frequency transform result to the WiFi baseband unit 116. For example, the WiFi radio unit 114 includes a transmitter, a multiplier, an amplifier, an attenuator, an AGC (Automatic Gain Control), and the like, and is implemented by an analog circuit and the like. Further, the WiFi radio unit 114 performs frequency transform on a signal output from the WiFi baseband unit 116, and transmits the signal which has been subjected to the frequency transform to the outside through the WiFi antenna 112.

The WiFi baseband unit 116 converts a signal received through the WiFi radio unit 114 into a baseband signal, and then converts the converted signal into a digital signal by an A/D converter. Further, the WiFi baseband unit 116 performs various processes such as a demodulation process and an error correction process on the converted digital signal. For example, the WiFi baseband unit 116 is implemented by a CPU, a DSP, or the like.

The WiMAX radio unit 124 receives a radio signal of a variety of data such as a sound or a text that conforms to, for example, the WiMAX scheme which is a standard of fixed wireless communication through the WiMAX antenna 122, performs frequency transform on the radio signal, and outputs a frequency transform result to the WiMAX baseband unit 126. The WiMAX radio unit 124 includes a transmitter, a multiplier, an amplifier, an attenuator, an AGC (Automatic Gain Control), and the like, and is implemented by an analog circuit and the like. Further, the WiMAX radio unit 124 performs frequency transform on a signal output from the WiMAX baseband unit 126, and transmits the signal which has been subjected to the frequency transform to the outside through the WiMAX antenna 122.

The WiMAX baseband unit 126 converts a signal received through the WiMAX radio unit 124 into a baseband signal, and then converts the converted signal into a digital signal by an A/D converter. The WiMAX baseband unit 126 performs various processes such as a demodulation process and an error correction process on the converted digital signal. For example, the WiMAX baseband unit 126 is implemented by a CPU, a DSP, or the like.

For example, the processor 130 is a CPU that executes various programs stored in the memory 180. By executing various programs stored in the memory 180, the processor 130 controls the 3G baseband unit 106, the WiFi baseband unit 116, the WiMAX baseband unit 126, and the like. A program executed by the processor 130 is not only stored in the memory 180 but also recorded in a distributable recording medium such as a CD (Compact Disc)-ROM (Read Only Memory) or a memory medium, read from the recording medium, and executed. Further, a program may be stored in a server connected via a network to operate on the server, and a service may be provided to a terminal device of a request source connected via a network according to a request from the terminal device.

The display unit 140 is an output interface, such as a liquid crystal (LC) panel, which displays a variety of information such as a text or an image. The operating unit 150 includes a key panel, a touch panel, and the like installed in the wireless terminal device 100, and an input interface that receives the user's input operation. The microphone 160 is an input interface that receives a sound around the wireless terminal device 100. The speaker 170 is an output interface that outputs a sound to the outside of the wireless terminal device 100.

The memory 180 is a storage medium that stores data used to execute various functions of the wireless terminal device 100 and various programs for executing various functions. For example, the memory stores a communication mode selection register, and RSSI/CINR threshold values in the WiMAX only communication mode and the WiMAX dual communication mode. The communication mode selection register and the RSSI/CINR threshold value will be described later.

Next, functional blocks of the processor 130 will be described. FIG. 4 is a diagram illustrating functional blocks of the processor. As illustrated in FIG. 4, the processor 130 includes a display control unit 230, an input control unit 231, a mode selecting unit 232, a threshold value control unit 234, and a communication switching control unit 236.

The display control unit 230 executes control related to a display image displayed on the display unit 140. For example, the display control unit 230 displays a communication mode setting screen through which the user performs an operation of setting a communication mode. Here, the operation of setting a communication mode refers to an operation of selecting, for example, the WiMAX only communication mode or the WiMAX dual communication mode in order to perform communication.

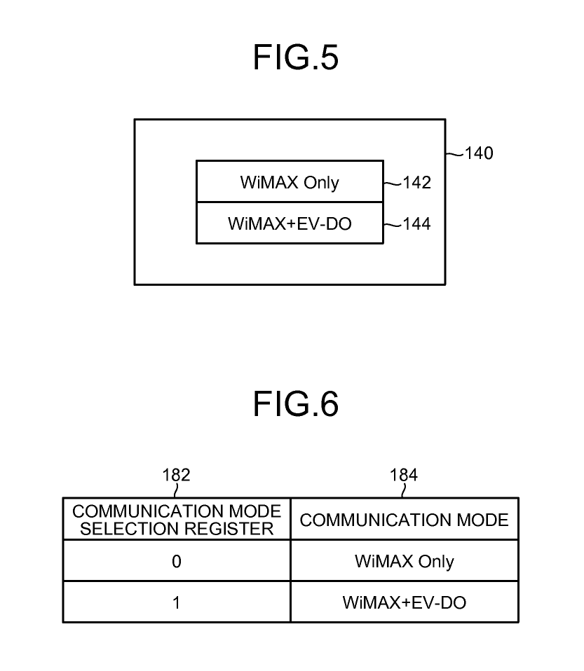

FIG. 5 is a diagram illustrating an example of selecting a communication mode on a screen of the wireless terminal device. As illustrated in FIG. 5, a WiMAX only selection screen 142 for selecting the WiMAX only communication mode and a WiMAX+EV-DO selection screen 144 for selecting the WiMAX dual communication mode are displayed on the display unit 140.

Referring back to FIG. 4, the input control unit 231 receives an input command from the user through the operating unit 150. For example, the input control unit 231 receives an input signal representing that the WiMAX only selection screen 142 is selected or an input signal representing that the WiMAX+EV-DO selection screen 144 is selected through the operating unit 150, and outputs the input signal to the mode selecting unit 232.

The mode selecting unit 232 selects either the WiMAX only communication mode or the WiMAX dual communication mode according to the input signal input through the input control unit 231 (input interface). For example, when the WiMAX only communication mode or the WiMAX dual communication mode is selected, the mode selecting unit 232 rewrites a value of the communication mode selection register stored in the memory 180. The communication mode selection register will be described below.

FIG. 6 is a diagram illustrating an example of the communication mode selection register. As illustrated in FIG. 6, a value of “0” or “1” is stored in a communication mode selection register 182. Further, as illustrated in FIG. 6, the value of the communication mode selection register 182 is associated with setting content of a communication mode 184 in a one-to-one manner. For example, when the communication mode 184 is set to WiMAX Only, the mode selecting unit 232 stores a value of “0” in the communication mode selection register 182. Further, for example, when the communication mode 184 is set to WiMAX+EV-DO (WiMAX Dual), the mode selecting unit 232 stores a value of “1” in the communication mode selection register 182.

Referring back to FIG. 4, the threshold value control unit 234 sets a connection determination threshold value, which is used to determine whether or not to establish a wireless connection by the WiMAX scheme, to a different value according to the wireless communication mode selected by the mode selecting unit 232. Here, for example, the RSSI or the CINR of a radio signal transmitted from the WiMAX base station is used as the connection determination threshold value. The RSSI threshold value and the CINR threshold value will be described below.

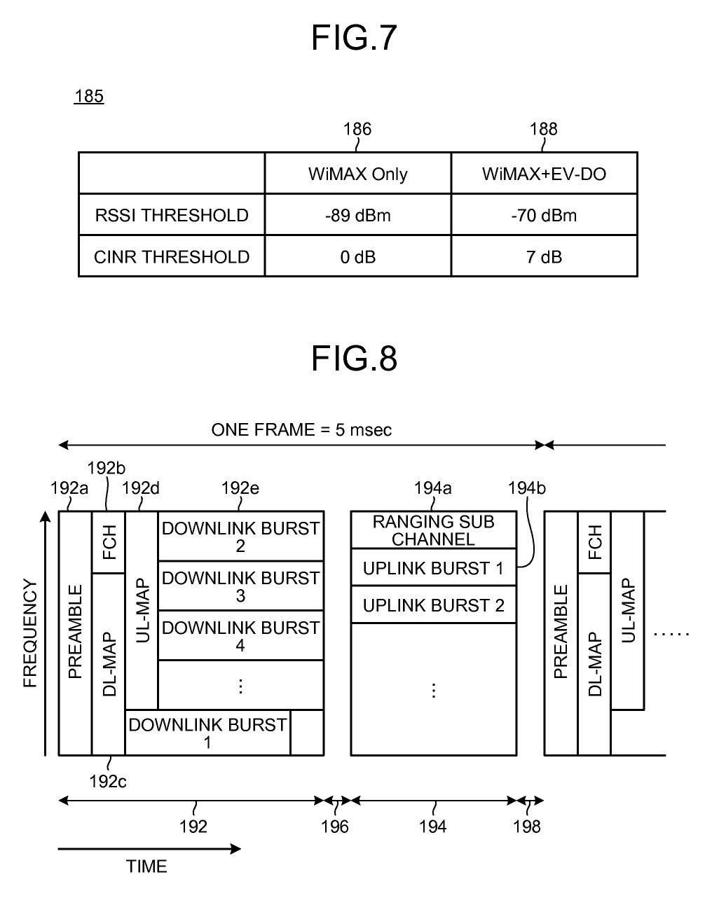

FIG. 7 is a diagram illustrating an example of RSSI/CINR threshold values in the WiMAX only communication mode and the WiMAX dual communication mode. A threshold value table 185 illustrated in FIG. 7 is stored in the memory 180. For example, when a WiMAX only communication mode 186 remains set, the threshold value control unit 234 sets the RSSI threshold value to −89 dBm, and sets the CINR threshold value to 0 dB. Further, for example, a WiMAX+EV-DO communication mode 188 remains set, the threshold value control unit 234 sets the RSSI threshold value to −70 dBm, and sets the CINR threshold value to 7 dB. As described above, when the WiMAX dual communication mode is selected by the mode selecting unit 232, the threshold value control unit 234 sets the RSSI threshold value and the CINR threshold value to larger values than the RSSI threshold value and the CINR threshold value set when the WiMAX only communication mode is selected. In other words, when the WiMAX dual communication mode is selected, the threshold value control unit 234 sets the RSSI threshold value and the CINR threshold value which are more difficult to cause switching to the WiMAX connection than the RSSI threshold value and the CINR threshold value set when the WiMAX only communication mode is selected. The present invention is not limited to the example in which the threshold value control unit 234 sets both the RSSI threshold value and the CINR threshold value, and may set any one of the RSSI threshold value and the CINR threshold value.

Referring back to FIG. 4, the communication switching control unit 236 mutually switches packet communication by the EV-DO scheme and packet communication by the WiMAX scheme. For example, when packet communication is being performed by the EV-DO scheme, the communication switching control unit 236 switches to packet communication by the WiMAX scheme when the RSSI of the radio signal transmitted from the WiMAX base station is larger than the RSSI threshold value and the CINR of the radio signal transmitted from the WiMAX base station is larger than the CINR threshold value. Further, when packet communication is being performed by the WiMAX scheme, the communication switching control unit 236 switches to packet communication by the EV-DO scheme when the RSSI of the radio signal transmitted from the WiMAX base station is smaller than the RSSI threshold value and the CINR of the radio signal transmitted from the WiMAX base station is smaller than the CINR threshold value.

More specifically, the communication switching control unit 236 receives a WiMAX physical channel by five frames, and calculates an RSSI average value of the five frames and a CINR average value of the five frames. Then, when the calculated RSSI average value is larger than the RSSI threshold value and the calculated CINR average value is larger than the CINR threshold value, the communication switching control unit 236 starts packet communication by the WiMAX scheme. A frame format of the WiMAX physical channel is described below.

FIG. 8 is a diagram illustrating an example of a frame format of the WiMAX physical channel. As illustrated in FIG. 7, one frame of a WiMAX physical channel includes a downlink sub frame 192, a TTG (Tx/Rx Transition Gap) 196, an uplink sub frame 194, and an RTG (Rx/Tx Transition Gap) 198 in order from the head. A reception time of one frame of the WiMAX physical channel is about 5 ms.

The downlink sub frame 192 includes a preamble 192a, an FCH (Frame Control Header) 192b, a DL-MAP (Down Link Mapping Message) 192c, an UL-MAP (Up Link Mapping Message) 192d, and a plurality of downlink burst groups 192e.

The preamble 192a is a preamble signal representing that the WiMAX physical channel is transmitted. The FCH 192b is broadcast information that is transmitted in a predetermined format, and is transmitted to notify a terminal of a modulation scheme or an encoding scheme of a MAP area, and the like so that control information such as the subsequent DL-MAP can be properly read. The DL-MAP 192c and the UL-MAP 192d are control signals transmitted as information representing the position (a frequency and a time slot) of user data included in each of the downlink burst groups 192e. The downlink burst group 192e includes downlink user data.

The uplink sub frame 194 includes a ranging sub channel 194a and a plurality of uplink burst groups 194b. The ranging sub channel 194a is used for a ranging process in which the wireless terminal device 100 performs time synchronization correction or transmission power correction on the WiMAX base station. The uplink burst group 194b includes uplink user data.

Since the preamble 192a is assigned to the head of the frame of the WiMAX physical channel as described above, the communication switching control unit 236 counts the number of frames each time when the preamble 192a is received. For example, when the WiMAX physical channel of five frames is received, the communication switching control unit 236 calculates an RSSI average value of the five frames and a CINR average value of the five frames. Then, when the calculated RSSI average value is larger than the RSSI threshold value and the calculated CINR average value is larger than the CINR threshold value, the communication switching control unit 236 starts packet communication by the WiMAX scheme. The communication switching control unit 236 performs synchronization and initial ranging of WiMAX communication when packet communication by the WiMAX scheme starts. The synchronization and initial ranging of WiMAX communication will be described below.

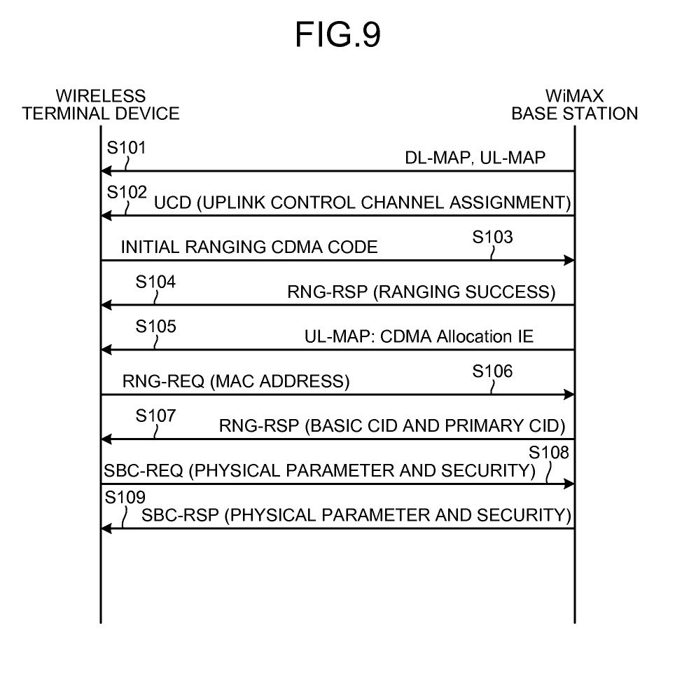

FIG. 9 is a diagram illustrating an example of a synchronization and initial ranging process of WiMAX communication. First, the WiMAX base station transmits uplink/downlink MAP information, and the wireless terminal device 100 acquires the uplink/downlink MAP information (step S101). Next, the WiMAX base station transmits UCD uplink burst profile information (including information related to ranging), and the wireless terminal device 100 acquires the UCD uplink burst profile information (step S102). Subsequently, the wireless terminal device 100 transmits an initial ranging CDMA code to the WiMAX base station, and performs initial ranging using the CDMA code (step S103).

Subsequently, the WiMAX base station notifies the wireless terminal device 100 of that the initial ranging has been successfully performed by transmitting an RNG-RSP (Ranging Response) (step S104). Subsequently, the WiMAX base station transmits a CDMA Allocation IE which the wireless terminal device 100 uses in order to transmit a RNG-REQ (Ranging Request) (step S105). Upon receiving the CDMA Allocation IE, the wireless terminal device 100 transmits the RNG-REQ to the WiMAX base station (step S106).

Subsequently, the WiMAX base station transmits the RNG-RSP to the wireless terminal device 100 and thus assigns a basic CID (Connection Identifier) through which the WiMAX base station uniquely identifies the wireless terminal device 100, and a primary CID (step S107). Subsequently, the wireless terminal device 100 transmits an SBC-REQ (Subscriber station Basic Capability REQuest) to the WiMAX base station (step S108). The WiMAX base station transmits an SBC-RSP to the wireless terminal device 100 (step S109). Through this process, the wireless terminal device 100 exchanges information such as a physical parameter and a security parameter with the WiMAX base station.

Further, the physical parameter information of the SBC-REQ/SBC-RSP includes an OFDM (Orthogonal Frequency Division Multiplexing) SS (Spread Spectrum) demodulator (64 QAM (Quadrature Amplitude Modulation) support and sub channelizing support). Further, the physical parameter information of the SBC-REQ/SBC-RSP includes an OFDM SS modulator (64 QAM support and sub channelizing support). Further, the physical parameter information of the SBC-REQ/SBC-RSP includes an OFDMA (Orthogonal Frequency Division Multiple Access) FFT (Fast Fourier Translation sizes (FFT sizes 128, 256, 512, 1024, and 2048 support). Further, the physical parameter information of the SBC-REQ/SBC-RSP includes an OFDMA SS permutation support (permutation mode support). Further, the physical parameter information of the SBC-REQ/SBC-RSP includes an OFDMA demodulator for MIMO (Multiple-Input and Multiple-Output) support (the number of receiving MIMO antennas and STC (Space Time Coding) support). Further, the physical parameter information of the SBC-REQ/SBC-RSP includes an OFDMA SS MIMO uplink support (the number of transmitting MIMO antennas and transmission diversity support).

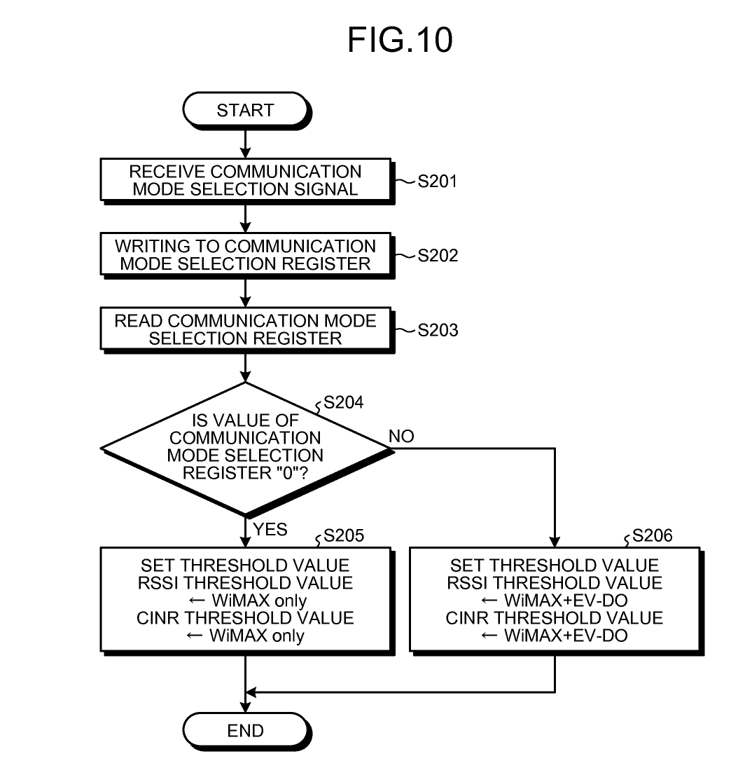

Next, a process of setting the RSSI threshold value and the CINR threshold value of the wireless terminal device 100 will be described. FIG. 10 is a flowchart of a process of setting the RSSI threshold value and the CINR threshold value of the wireless terminal device. As illustrated in FIG. 10, first, the input control unit 231 receives a communication mode selection signal through the operating unit 150 (step S201). For example, the input control unit 231 receives a communication mode selection signal representing selection of the WiMAX only communication mode or a communication mode selection signal representing selection of the WiMAX dual communication mode through the operating unit 150.

Subsequently, the mode selecting unit 232 performs writing to the communication mode selection register 182 based on the communication mode selection signal received by the input control unit 231 (step S202). For example, when the communication mode selection signal representing selection of the WiMAX only communication mode is received, the mode selecting unit 232 writes a value of “0” in the communication mode selection register 182. Further, when the communication mode selection signal representing selection of the WiMAX dual communication mode is received, the mode selecting unit 232 writes a value of “1” in the communication mode selection register 182.

Subsequently, the threshold value control unit 234 reads the value of the communication mode selection register 182 (step S203). Subsequently, the threshold value control unit 234 determines whether or not the read value of the communication mode selection register 182 is “0” (step S204).

Here, when the value of the communication mode selection register 182 is “0” (Yes in step S204), the threshold value control unit 234 sets the threshold value of WiMAX Only as the RSSI threshold value, and sets the threshold value of WiMAX Only as the CINR threshold value (step S205). For example, the threshold value control unit 234 sets “−89 dBm” and “0 dB” as the RSSI threshold value and the CINR threshold value, respectively, with reference to the threshold value table 185.

However, when the value of the communication mode selection register 182 is not “0” (No in step S204), the threshold value control unit 234 sets the threshold value of WiMAX+EV-DO as the RSSI threshold value, and sets the threshold value of WiMAX+EV-DO as the CINR threshold value (step S206). For example, the threshold value control unit 234 sets “−70 dBm” and “7 dB” as the RSSI threshold value and the CINR threshold value, respectively, with reference to the threshold value table 185.

As described above, according to the wireless terminal device 100 of the present embodiment, it is possible to suppress power consumption when a communication mode using a plurality of communication schemes is selected. In other words, the wireless terminal device 100 according to the present embodiment changes the WiMAX connection determination threshold value when the user uses the multi-wireless terminal device of WiMAX and EV-DO in the WiMAX only communication mode or the WiMAX dual communication mode. For example, when the WiMAX dual communication mode is selected, the wireless terminal device 100 sets the WiMAX connection determination threshold value to a larger value, that is, a value which is more difficult to establish a WiMAX connection than when the WiMAX only communication mode is selected. Thus, it is possible to prevent an EV-DO connection from being established immediately after a WiMAX connection is established in a state in which the radio signal transmitted from the WiMAX base station is unstable. Accordingly, it is possible to suppress power consumption caused by frequent execution of switching between the WiMAX connection and the EV-DO connection, and thus the wireless terminal device 100 having a long battery life can be provided.

Further, when an operation is being performed in the WiMAX dual communication mode, switching to WiMAX is not performed unless the field intensity RSSI or CINR of WiMAX is higher than a certain level. Thus, when switching to WiMAX has been performed, WiMAX wireless communication can be stably performed.

Meanwhile, when an operation is being performed in the WiMAX only communication mode, the wireless terminal device 100 sets the WiMAX connection determination threshold value to a smaller value, that is, a value which is easily to establish the WiMAX connection than in the WiMAX dual communication mode. In other words, when an operation is being performed in the WiMAX only communication mode, the wireless terminal device 100 does not establish the EV-DO connection, and thus can immediately start the WiMAX wireless connection in a place where the WiMAX radio signal is relatively weak and unstable.

The present embodiment has been described in connection with the wireless terminal device 100 in which the WiMAX scheme and the EV-DO scheme are used together. However, the present embodiment is not limited to this example, and can be applied to various communication schemes. In other words, the present embodiment is not limited to the WiMAX scheme, and can be applied to various communication schemes such as WiMAX 16e, WiMAX 16m, LTE (Long Term Evolution), WiFi, FDD (Frequency Division Duplex)-LTE, and LTE-Advanced. Further, the present embodiment is not limited to the EV-DO scheme, and can be applied to various communication schemes such as W-CDMA scheme which is specified in the 3G mobile communication scheme.

Further, the present embodiment has been described in connection with the wireless terminal device 100 and the wireless communication method, but the present embodiment is not limited to this example. For example, the same functions as in the above-described embodiment can be implemented by executing a wireless communication program which is prepared in advance through a wireless terminal device. In other words, the wireless communication program causes the wireless terminal device to execute a process of selecting a first wireless communication mode in which communication is performed by a first wireless scheme or a second wireless communication mode in which communication is performed using a plurality of communication scheme including the first wireless scheme together, according to an input signal input through an input interface. Further, wireless communication program causes the wireless terminal device to execute a process of setting a connection determination threshold value, which is used to determine whether or not to establish a wireless connection by the first wireless scheme, to a different value according to the selected wireless communication mode.

Further, the wireless communication program can be distributed to the wireless terminal device via a network such as the Internet. Furthermore, the wireless communication program may be recorded in a memory, a hard disk, or any other computer readable recording medium, which is disposed in the wireless terminal device, and the wireless terminal device may read the wireless communication program from the recording medium and then executes the wireless communication program.

According to an aspect of a wireless terminal device of the present disclosure, it is possible to suppress power consumption when a communication mode using a plurality of communication schemes is selected.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A wireless terminal device that is able to perform communication by a plurality of communication schemes, comprising:
a processor that selects a first wireless communication mode in which communication is performed by a first wireless scheme or a second wireless communication mode in which communication is performed using a plurality of communication schemes including the first wireless scheme, according to an input signal input through an input interface, and sets a connection determination threshold value, which is used to determine whether or not to establish a wireless connection by the first wireless scheme, to a different value according to the selected wireless communication mode.

2. The wireless terminal device according to claim 1,
wherein the processor selects the first wireless communication mode which is a communication mode in which wireless communication is performed by the first wireless scheme when the wireless terminal device is located in a communication area of the first wireless scheme and wireless communication is not performed when the wireless terminal device is not located in the communication area of the first wireless scheme, or the second wireless communication mode which is a wireless communication mode in which wireless communication is performed by the first wireless scheme when the wireless device is located in the communication area of the first wireless scheme and wireless communication is performed by another wireless scheme when the wireless device is not located in the communication area of the first wireless scheme but located in a communication area of the other wireless scheme.

3. The wireless terminal device according to claim 1,
wherein the processor sets the connection determination threshold value, which is an RSSI (Received Signal Strength Indicator) of a radio signal by the first wireless scheme or a CINR (Carrier to Interference and Noise Ratio) of a radio signal by the first wireless scheme, to a different value according to the selected wireless communication mode.

4. The wireless terminal device according to claim 1,
wherein the processor switches to communication by the first wireless scheme when the RSSI of the radio signal by the first wireless scheme or the CINR of the radio signal by the first wireless scheme is larger than the connection determination threshold value, and
the processor sets the connection determination threshold value when the second wireless communication mode is selected to a larger value than the connection determination threshold value set when the first wireless communication mode is selected.

5. The wireless terminal device according to claim 1,
wherein the first wireless communication mode is a wireless communication mode in which wireless communication is performed by a WiMAX wireless scheme when the wireless terminal device is located in a communication area of the WiMAX wireless scheme and wireless communication is not performed when the wireless terminal device is not located in the communication area of the WiMAX wireless scheme, and
the second wireless communication mode is a wireless communication mode in which wireless communication is performed by the WiMAX wireless scheme when the wireless terminal device is located in the communication area of the WiMAX wireless scheme and wireless communication is performed by a 3rd generation mobile communication scheme when the wireless terminal device is not located in the communication area of the WiMAX wireless scheme but located in a communication area of the 3rd generation mobile communication scheme.

6. A wireless communication method, comprising:
selecting, by a wireless terminal device, a first wireless communication mode in which communication is performed by a first wireless scheme or a second wireless communication mode in which communication is performed using a plurality of communication schemes including the first wireless scheme, according to an input signal input through an input interface; and
setting, by the wireless terminal device, a connection determination threshold value, which is used to determine whether or not to establish a wireless connection by the first wireless scheme, to a different value according to the selected wireless communication mode.
